(19) United States
(12) Patent Application Publication
(10) Pub. No.: US 2015/0007133 A1
(43) Pub. Date: Jan. 1, 2015

(54) Content Package Generation for Web Content

(71) Applicant: ADOBE SYSTEMS INCORPORATED, San Jose, CA (US)

(72) Inventor: Damien M. Antipa, Saint-Louis (FR)

(21) Appl. No.: 13/929,660

(22) Filed: Jun. 27, 2013

(51) Int. Cl. G06F 9/44

(52) U.S. Cl. CPC G06F 8/31
USPC 717/114

(57) ABSTRACT

Content package generation techniques are described. In one or more implementations, one or more inputs are received via an authoring tool of a computing device to compose a web content project in accordance with a dynamic stylesheet language. The web content project is processed into a content package automatically and without user intervention by the computing device. The processing includes verifying syntax of the web content project, performing one or more unit tests on web content project, and taking portions of the web content project into corresponding locations in a hierarchical structure of nodes of the content package.

### BACKGROUND

There is an ever increasing amount of web content made available via the Internet for consumption by a browser, a web-enabled application, and so on. Developers may employ a variety of different techniques to compose and deploy this web content for consumption by users.

However, conventional techniques that are available to developers did not adequately address a transition between composing the web content and deployment of the content. Accordingly, these conventional techniques could be frustrating and time consuming to developers, which often resulted in the developers forgoing use of the techniques.

### SUMMARY

Content package generation techniques are described. In one or more implementations, one or more inputs are received via an authoring tool of a computing device to compose a web content project in accordance with a dynamic stylesheet language. The web content project is processed into a content package automatically and without user intervention by the computing device. The processing includes verifying syntax of the web content project, performing one or more unit tests on web content project, and taking portions of the web content project into corresponding locations in a hierarchical structure of nodes of the content package.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a system in an example implementation in which a web content project is developed and one or more techniques are performed to process the web content project into a content package.

FIG. 3 depicts a system in an example implementation in which one or more additional techniques are performed to process the web content project into a content package.

FIG. 4 depicts a system in an example implementation in which one or more techniques are performed to process the web content project into a content package.

FIG. 5 is a flow diagram depicting a procedure in an example implementation in which a procedure is shown to generate a content package from one or more static files of a web content project.

FIG. 6 illustrates an example system including various components of an example device that can be implemented as any type of computing device as described and/or utilize with reference to FIGS. 1-5 to implement embodiments of the techniques described herein.

### DETAILED DESCRIPTION

Overview

Conventional techniques that are utilized to generate content packages are often limited in support of transitions between developing the web content and generating a package that includes the web content. Accordingly, conventional techniques may rely on a variety of different manual processes to test and prepare the content for addition to an appropriate file structure and format, which could be frustrating to developers of web content that wish to leverage the content packages.

Content package generation techniques for web content are described. In one or more implementations, an automated system is described that may operate without user intervention to generate a content package. For example, a user may interact with an authoring tool to compose a web content project, such as in accordance with a LESS dynamic stylesheet language. The system may then be utilized to process the web content project into a content package, which may be configured for consumption via a content repository application programming interface (API).

For example, a user may provide one or more user inputs to initiate processing of the web content project (e.g., a command, gesture, use of a cursor control device, and so on) into a content package that is configured for consumption via a content repository API for Java® (JCR). This processing may include converting the web content project from a LESS configuration to a cascading style sheets (CSS) configuration, verification of syntax, processing of images if included, performing unit test cases, extracting inline documentation, taking portions of the web content project into corresponding locations in a hierarchical structure of the content package, installation on an executing content management system, and so on. In this way, the system may be utilized to package the web content as tested and verified automatically and without user intervention, thereby increasing a likelihood that these actions will be undertaken by a developer of the web content. Further discussion of these techniques may be found in relation to the following sections.

In the following discussion, an example environment is first described that may employ the techniques described herein. An implementation example and example procedures are then described which may be performed in the example environment as well as other environments. Consequently, performance of the example procedures is not limited to the example environment and the example environment is not limited to performance of the example procedures.

Example Environment

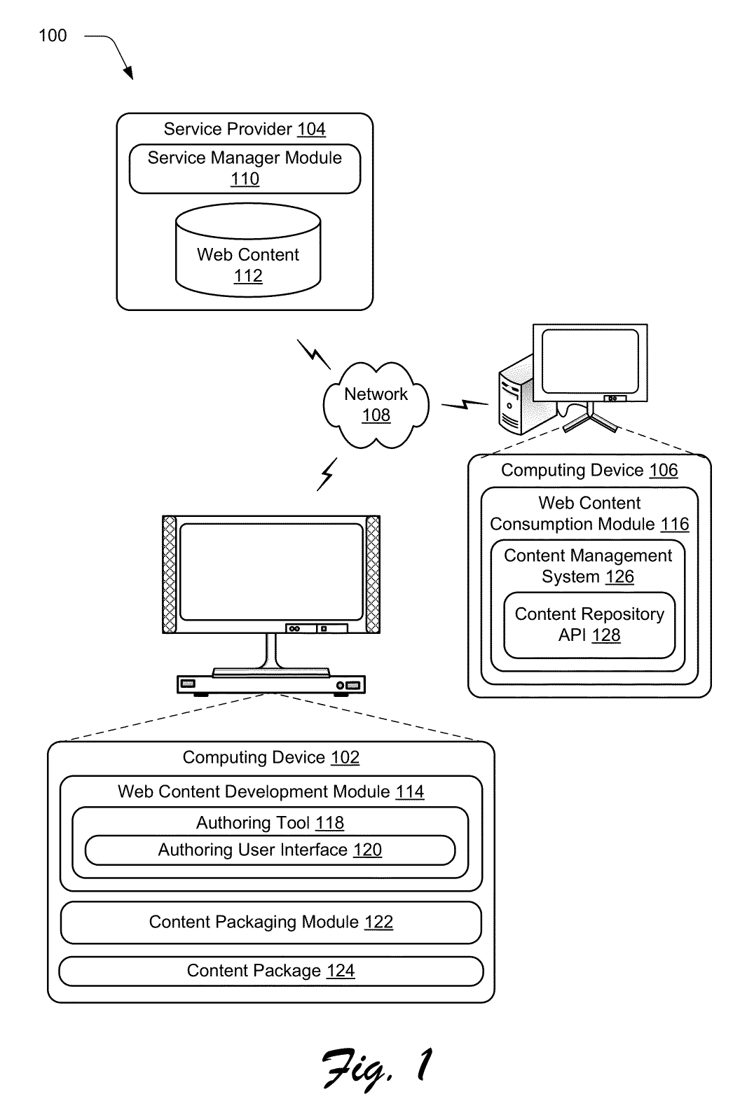

FIG. 1 is an illustration of an environment 100 in an example implementation that is operable to employ techniques described herein. The illustrated environment 100 includes a computing device 102, a service provider 104, and another computing device 106 that are communicative coupled via a network 108. The computing devices 102, 106, as well as the computing devices that implement the service provider 104, may be configured in a variety of ways.

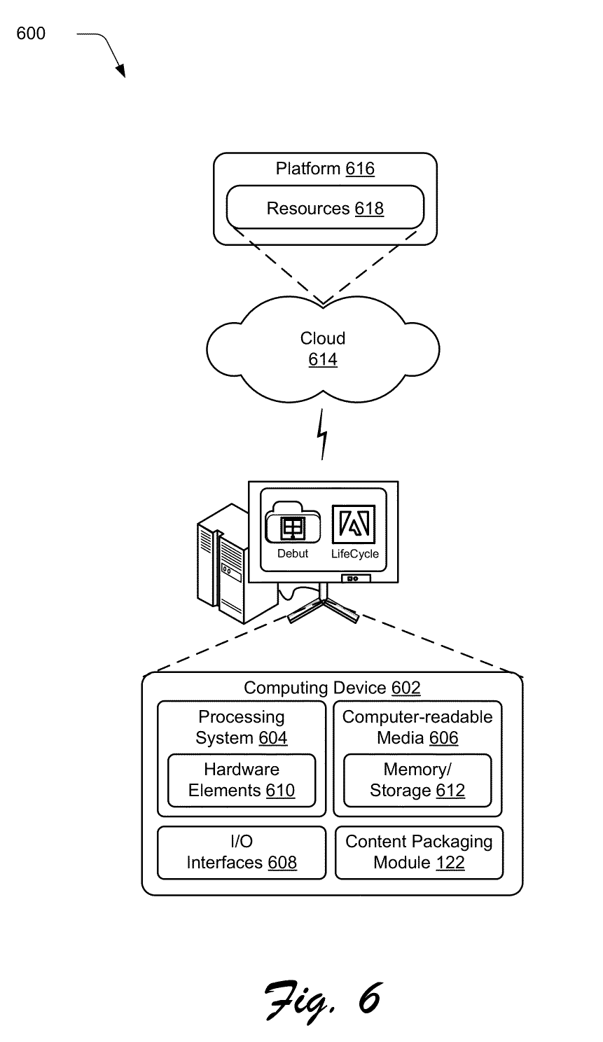

A computing device, for instance, may be configured as a desktop computer, a laptop computer, a mobile device (e.g., assuming a handheld configuration such as a tablet or mobile phone), and so forth. Thus, computing devices may range from full resource devices with substantial memory and processor resources (e.g., personal computers, game consoles) to a low-resource device with limited memory and/or processing resources (e.g., mobile devices). Additionally, although a single computing device may be described in the following, reference to a computing device may be representative of a plurality of different devices, such as multiple servers utilized by a business (e.g., the service provider 104) to perform operations “over the cloud” as further described in relation to FIG. 6.

Although the network 108 is illustrated as the Internet, the network may assume a wide variety of configurations. For example, the network 106 may include a wide area network (WAN), a local area network (LAN), a wireless network, a public telephone network, an intranet, and so on. Further, although a single network 108 is shown, the network 108 may also be configured to include multiple networks.

The service provider 104 is illustrated as including a service manager module 110. The service manager module 110 is representative of functionality of the service provider 104 to manage web content 112 as part of one or more network-based services. The web content 112 may be configured in a variety of ways, such as one or more webpages of a website, configured for access as part of a network-based application, and so on.

In the illustrated environment, the computing device 102 includes a web content development module 114 that is representative of functionality to compose the web content 112, e.g., for use by a developer. Computing device 106, on the other hand, is illustrated as including a web content consumption module 116 that is representative of functionality to consume the web content 112, e.g., as a browser, as part of a network-based application, and so on. Although illustrated separately, it should be readily apparent that the represented functionality may be combined on a single computing device (e.g., computing device 102 may be used to both develop and consume the content), may be further distributed (e.g., as part of a network service), and so on.

The web content developer module 114 is illustrated as including an authoring tool 118 that is executable to provide a user interface via which a developer may compose the web content 112. As such, the authoring tool 118 may be configured in a variety of different ways. For example, the authoring tool 118 may be configured to support a style sheet language to describe presentation of a web content project in a markup language, such as XML and so on.

A content packaging module 122 is also illustrated, which is representative of functionality that may be employed to package a web content project as a content package 124, e.g., the web content project received from the authoring tool 118 or elsewhere. The content packaging module 122, for instance, may configure the web content project in accordance with a hierarchical (e.g., tree-like) structure having a plurality of nodes with associated properties. Thus, a parent/child relationship of the nodes may also define a relationship of content associated with the nodes. In this way, the structure of the content package 124 may specify how content of the content package 124 is to be accessed.

As previously described, the computing device 106 includes a web content consumption module 116 that is representative of functionality to consume web content 112, which may include the content package 124 that was communicated for distribution via the network 108 by the service provider 104. The web content consumption module 116 includes a content management system 126 (CMS) having a content repository API 128. The content repository API 128 may be configured to follow a specification for access to the content package 124, such as in accordance with a content repository API for Java® (JCR) or other dynamic runtime language. The content management system 126 may thus be used to maintain and manage content associated with the content package 124 as well as content received via other techniques (e.g., as single files) via the content repository API 128, which may include versioning metadata and so on.

Thus, the content management system 126 may operate as a type of object database to store, search, and retrieve hierarchical content. As such, the content package 124 may also be configured by the content packaging module 122 in accordance with this database, such that a hierarchical structure of the content package 124 is configured in accordance with the hierarchical structure of the object database maintained by the content management system 126.

As previously described, conventional techniques that were utilized to generate a content package 124 did not support a transition between development of the content and building of the content package 124. This could cause developers to forgo use of testing and verification to make sure the web content “functions as intended.” However, the content packaging module 122 may perform operations associated with this transition automatically and without user intervention, such as through configuration as a configurable build system that aggregates several tools into a single configuration that provides a simple, configurable, and intuitive way to build a fully-tested content package 124. An example of such a system is described as follows and shown in corresponding figures.

Example Implementation

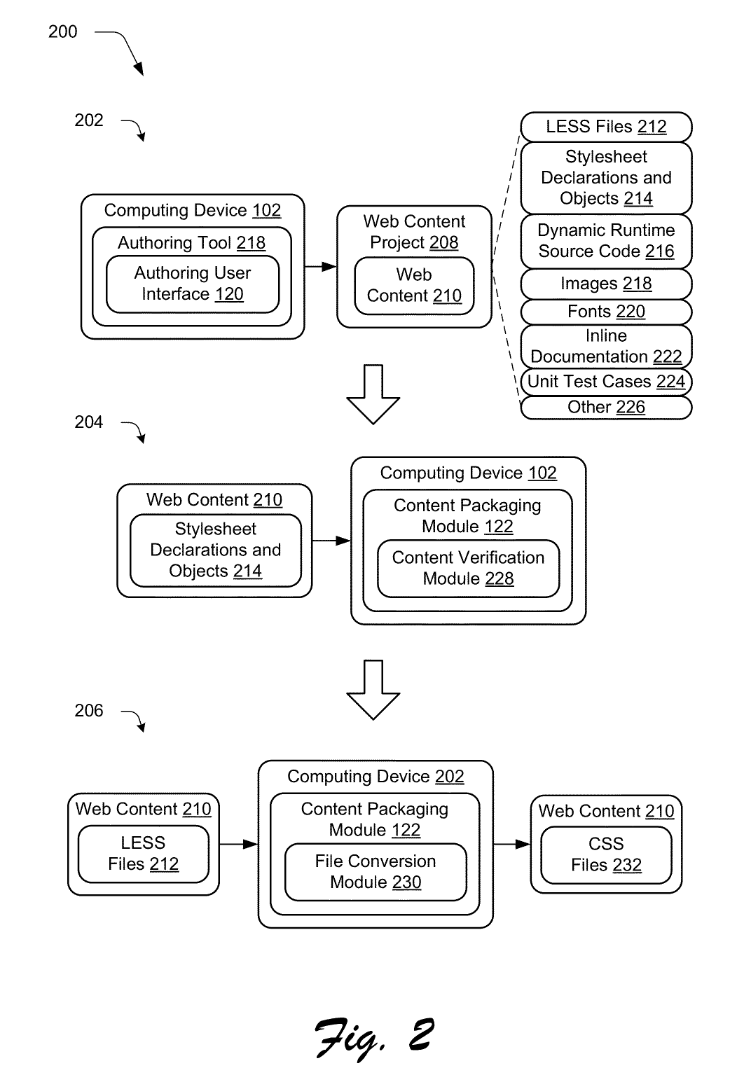

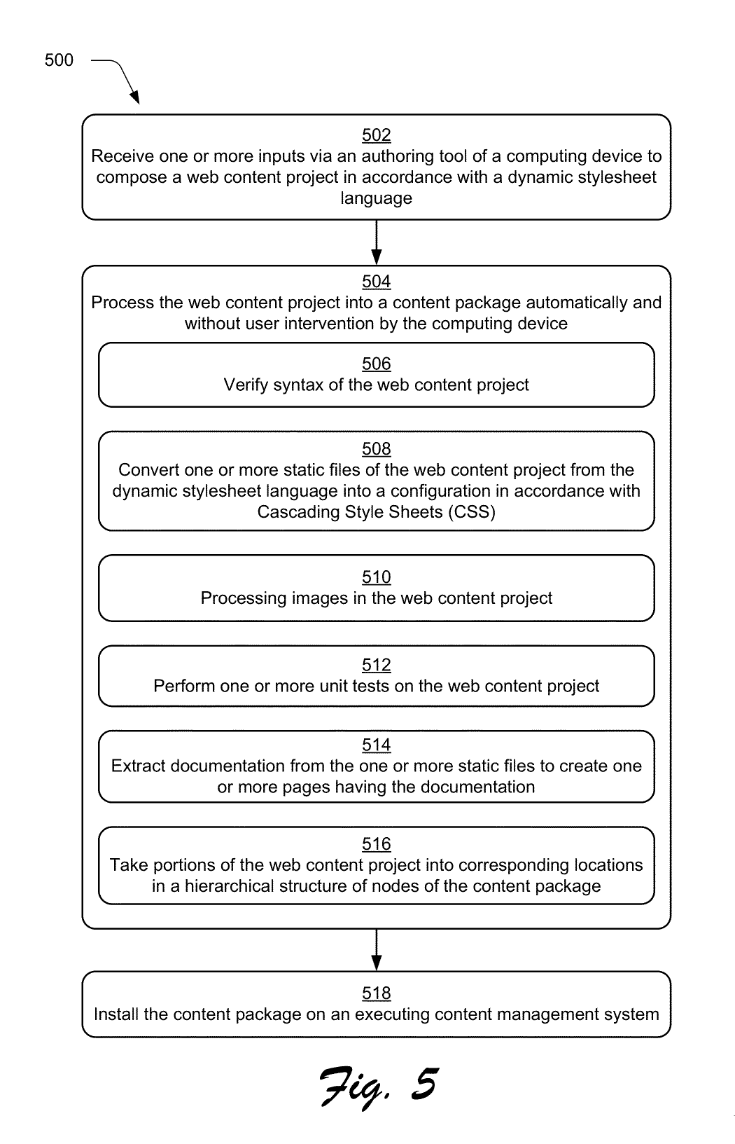

The following discussion describes content package generation techniques that may be implemented utilizing corresponding systems and devices, as well as other systems and devices. Further, the systems and devices may also be utilized to perform other procedures and arrangements thereof. Aspects of the procedure of FIG. 5 may be implemented in hardware, firmware, or software, or a combination thereof. The procedure 500 is shown as a set of blocks that specify operations performed by one or more devices as illustrated by the corresponding systems 200, 300, 400 of FIGS. 2-4 and are not necessarily limited to the orders shown for performing the operations by the respective blocks. Accordingly, the following discussion is arranged as including a description of the system and procedures in parallel.

FIG. 2 depicts a system 200 in an example implementation in which a web content project is developed and one or more techniques are performed to process the web content project into a content package. The system 200 is illustrated through the use of first, second, and third stages 202, 204, 206 in this example.

At the first stage 202, one or more inputs are received via an authoring tool of a computing device to compose a web content project in accordance with a dynamic stylesheet language (block 502). A developer, for instance, may interact with the authoring tool 218 to describe presentation semantics of a document, which may be expressed in a markup language such as XML. This may be performed in a variety of ways.

For example, the authoring tool 218 may be configured to support a dynamic stylesheet language, such as LESS, to generate a web content project 208 having web content 210. Therefore, instead of writing directly to a cascading style sheets (CSS) language directly, the authoring tool 218 may support the use of a variety of different functionality made available via the dynamic stylesheet language. This functionality may include mixins (e.g., which permit embedding of properties of a class into another class), variables and variable assignment, nesting (e.g., logical nesting in which the code blocks themselves are not nested, but rather selectors are nested to specify inheritance), operators and functions, and so on. Other examples are also contemplated in which the authorizing tool 218 is configured to accept one or more inputs to compose CSS directly.

As illustrated, the web content 210 may include a variety of different types of data, which may include a variety of different types of static content. Examples of this content include LESS files 212 as described above, stylesheet declarations and objects 214, dynamic runtime source code 216, may include images 218, fonts, inline documentation 222, unit test cases 224, and other 226 content. It should be readily apparent that portions of the data may be optionally included as part of the web content 210 of the web content project 208.

Regardless of how the web content 210 originated, the web content project 208 may then be processed into a content package automatically and without user intervention by a computing device (block 504). This may include use of a variety of different techniques responsive to a single input from a user to begin the processing, e.g., a command, gesture, voice command, and so on.

At the second stage 204, for instance, syntax of the web content project is verified (block 506). As described above, the web content 210 may include stylesheet declarations and objects 214. Accordingly, the content packaging module 122 may employ a content verification module 228 to check syntax, including type errors and so on. For example, declaratives (e.g., LESS/CSS declaratives) and objects (e.g., Javascript® or other dynamic runtime objects) may be linted and verified such that the declaratives and objects do not contain syntax errors or break defined styling rules of the stylesheet language.

At the third stage 206, one or more static files of the web content project are converted from the dynamic stylesheet language into a configuration in accordance with Cascading Style Sheets (CSS) (block 508). As previously describes, LESS files 212 may be generated for use of a variety of functionality such as nesting, variables, mixins, and so on. However, LESS files 212 may be incompatible with browsers and other functionality (e.g., web-enabled applications) that are configured to consume web content 210. Accordingly, the content packaging module 122 may leverage a file conversion module 230 to convert the LESS files into CSS files 232 or other stylesheet language that is consumable by such functionality.

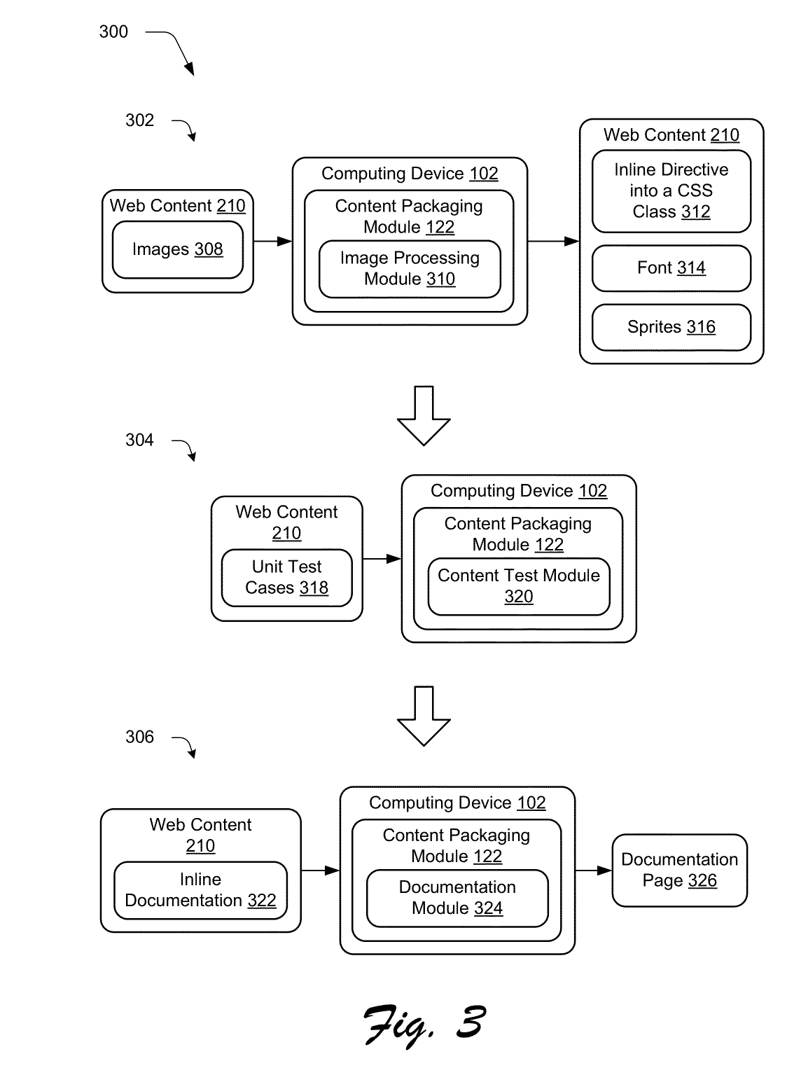

FIG. 3 depicts a system 300 in an example implementation in which one or more additional techniques are performed to process the web content project into a content package. The system 300 is also illustrated through the use of first, second, and third stages 302, 304, 306 in this example. At the first stage 302, images in the web content are processed (block 510), if included. For example, the web content 210 may optionally include images 308, which may be configured in a variety of ways. Accordingly, the images 308 may be processed for inclusion as part of the web content project 210 in a corresponding variety of ways. This may include placement as an inline directive into a CSS class 312, such as by conversion into a format in accordance with Base 64 which is included as part of the CSS files. The images 308 may also be converted by the image processing module 310 into a font. This may include processing vector graphics (e.g., monochrome vector graphics) by the image processing module 310 into parts of a font file to support use in a manner that is similar to use of any other defined font. The image processing module 310 may also support techniques involving sprites 316 such that a portion of a larger image is defined. In this way, that portion may be used such that a larger image may be leveraged for a variety of uses. A variety of other examples are also contemplated.

At the second stage 304, one or more unit tests are performed on the web content project (block 512). As previously described, the web content 210 may include unit test cases 318. These unit test cases may be specified manually as part of the web content. Accordingly, a content test module 320 may be employed to perform these tests to determine if functions operate as intended, e.g., to test variables, mathematical operations, and so on. If one of the tests fail, the content packaging module 122 may cease processing of the web content 210 used to form the content package 124.

At the third stage 306, documentation is extracted from one or more static files of the web content 210 to create one or more pages having the documentation (block 514). As illustrated, the web content 210 may include inline documentation 322 as part of the source code of the web content 210. This inline documentation may be parsed and applied by a documentation module 324 to a template to form one or more documentation pages 326 that include this inline documentation. In this way, the documentation page 326 may serve as a resource to locate documentation that describes functions included in the source code in a markup language page that may be included as part of the content package 124.

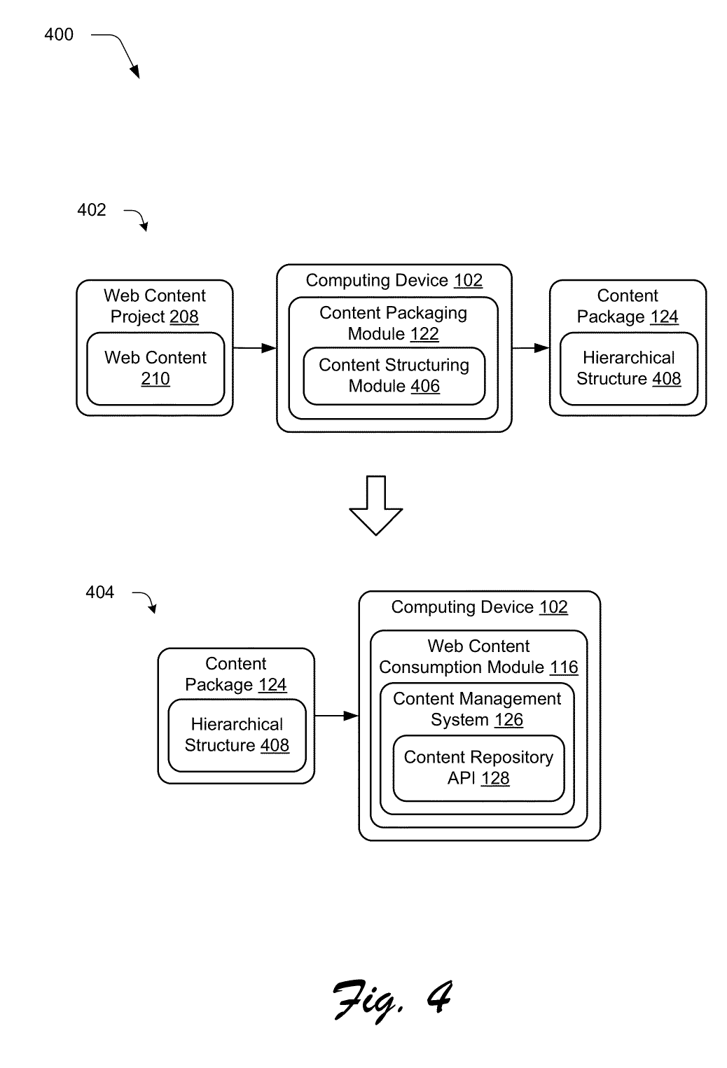

FIG. 4 depicts a system 400 in an example implementation in which one or more further techniques are performed to process the web content project into a content package. The system 400 is also illustrated through the use of first and second stages 402, 404.

At the first stage 402, portions of the web content project are taking into corresponding location in a hierarchical structure of nodes of the content package (block 516). The content structuring module 406, for instance, may be employed to process a result of one or more of the previous operations of FIGS. 2 and 3. This processing may include placement into a hierarchical structure 408 that corresponds to a client library structure of the content management system 126. In this way, the content package 214 is formed that is compatible with a content repository API 128 such that the content management system 126 knows “where” to place portions of the content package 124 (i.e., which nodes) in a content repository maintained by the content management system 126.

Additional operations may also be performed by the content structuring module 406. This may include formation of reference files, e.g., to be compatible with a content repository API for Java® (JCR) through generation of “js.txt” and “css.txt” files that include line-by-line lists of files to be used for JavaScript® and CSS files, respectively.

At the second stage 404, the content package 420 is illustrated as being installed on an actively executing content management system 126. The content package 124 as previously describe may include a hierarchical structure 408 that is understood via the content repository API 128, which is this instance is illustrated as being executed by a computing device 102 of the developer. Other examples are also contemplated, such as automatic upload of the content package 124 to the service provider 104 as part of the web content 112, output of a prompt to perform this upload, and so on.

Example System and Device

FIG. 6 illustrates an example system generally at 600 that includes an example computing device 602 that is representative of one or more computing systems and/or devices that may implement the various techniques described herein. This is illustrated through inclusion of the content packaging module 122, which may be configured to package web content as described above. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving one or more inputs via an authoring tool of a computing device to compose a web content project in accordance with a dynamic stylesheet language; and
processing the web content project into a content package automatically and without user intervention by the computing device, the processing including:
verifying syntax of the web content project;
performing one or more unit tests on the web content project; and
taking portions of the web content project into corresponding locations in a hierarchical structure of nodes of the content package.

2. A method as described in claim 1, wherein the processing includes converting one or more static files of the web content project from the dynamic stylesheet language into a configuration in accordance with Cascading Style Sheets (CSS).

3. A method as described in claim 2, wherein the converting includes converting inherited rules, nesting, mixins, or variables to comply with CSS.

4. A method as described in claim 2, wherein the authoring tool is configured to support the dynamic stylesheet language as a LESS stylesheet language.

5. A method as described in claim 1, wherein the processing of the web content project ceases in an event of failure of the one or more unit tests.

6. A method as described in claim 1, wherein the verifying of the syntax includes verifying that declaratives and objects of the web content project do not contain syntax errors or break defined styling rules.

7. A method as described in claim 1, wherein the taking of the one or more static files into the hierarchical structure of nodes of the content repository is performed such that portions of the one or more static files are placed at corresponding nested locations within the hierarchical structure of the nodes.

8. A method as described in claim 1, wherein the taking include forming a list of files that are included in the content package for processing by a content management system.

9. A method as described in claim 1, wherein the processing further comprises extracting documentation from the one or more static files to create one or more pages having the documentation, the extracting including extracting one or more inline descriptions of functions from source code of the one or more static files.

10. A method as described in claim 1, wherein the processing further comprises converting one or more vector graphics into a font.

11. A method as described in claim 1, wherein the processing further comprises marking part of an image for use as a sprite.

12. A method as described in claim 1, wherein the content package is configured for consumption via a content repository application programming interface (API).

13. A system comprising:
one or more modules implemented at least partially in hardware, the one or more modules configured to process a web content project into a content package automatically and without user intervention that is configured for consumption via a content repository application programming interface (API), the processing including:
performing one or more unit tests on the web content project;
extracting documentation from the web content project to create one or more pages having the documentation; and
taking the web content project into a hierarchical structure of nodes of the content package.

14. A system as described in claim 13, wherein the performing of the one or more unit tests include performing test to functions or variables to determine if syntax of the web content project is correct.

15. A system as described in claim 13, wherein the extracting of the documentation includes extracting one or more descriptions of functions from source code of the web content project.

16. A system as described in claim 13, wherein the taking of the web content project into the hierarchical structure of nodes of the content package is performed such that portions of the web content project are placed at corresponding nested locations within the hierarchical structure of the nodes.

17. One or more computer-readable storage media comprising instructions that are stored thereon that, responsive to execution by a computing device, causes the computing device to perform operations comprising processing a web content project configured in according with a dynamic stylesheet language into a content package automatically and without user intervention, the processing including:
performing one or more unit tests on the web content project;
extracting documentation from the web content project to create one or more pages having the documentation; and
taking the web content project into a hierarchical structure of nodes of the content package.

18. One or more computer-readable storage media as described in claim 17, wherein the performing of the one or more unit tests include testing functions or variables to determine if syntax of source code of the web content project is correct.

19. One or more computer-readable storage media as described in claim 17, wherein the extracting of the documentation includes extracting one or more descriptions of functions from source code of the web content project.

20. One or more computer-readable storage media as described in claim 17, wherein the taking of the web content project into the hierarchical structure of nodes of the content repository is performed such that portions of the web content project are placed at corresponding nested locations within the hierarchical structure of the nodes.
